(19) United States
(12) Patent Application Publication
(10) Pub. No.: US 2004/0028901 A1
(43) Pub. Date: Feb. 12, 2004

(54) Compositions comprising continuous networks and monoliths

(76) Inventors: Frederick H. Rumpf, Billerica, MA (US); Agathagelos Kyrlidis, Malden, MA (US); Feng Gu, Westford, MA (US); Curtis E. Adams, Watertown, MA (US)

Correspondence Address: Martha Finnegan, Esq., Cabot Corporation, 157 Concord Road, P.O. Box 7001, Billerica, MA, 01821-7001, US

(21) Appl. No.: 10/374,743

(22) Filed: Feb. 25, 2003

Related U.S. Application Data
(60) Provisional application No. 60/359,550, filed on Feb. 25, 2002.
(60) Provisional application No. 60/359,502, filed on Feb. 25, 2002.

(51) Int. Cl. D02G 3/00

(52) U.S. Cl. 428/375; 428/397; 428/401

(57) ABSTRACT

The present invention provides porous composition, such as those monoliths with tortuous flow through channels from aggregates comprising small particles. The present invention also relates to methods of making these solid networks and the use of these networks for a variety of functions. The nanoporous solid can be formed into a wide variety of macroscopic shapes and sizes and can be used as chromatographic supports, supports for solid phase chemistry, high surface area packing for chemical reactors, and separation, mixing, or reaction matrix for microfluidics devices. The method of making these networks comprises high shearing of the particles via, for example, a homogenizer, in an incompatible fluid so that the particles form a continuous open network. The method also comprises cross-linking the particles together via a linker species to “lock-in” the open network structure formed during shearing. The present invention relates to surface modified carbonaceous material and inorganic oxide membranes and monoliths. In particular the invention relates to membranes and/or monoliths comprising a carbonaceous material and/or inorganic oxide (such as zirconia or titania), functionalized with an organic functional group. This organic functional group, either a small molecule or a polymer, can be chosen for specific end-uses, such as selective protein binding, ion exchange, hydrophobic interaction, chiral selection to enhance separations technology.

### RELATED APPLICATIONS

This application claims the benefit of priority to U.S. Provisional Application No. 60/359,550, filed Feb. 25, 2002, and U.S. Provisional Application No. 60/359,502, filed Feb. 25, 2002, the disclosures of which are incorporated herein in their entirety.

### FIELD OF THE INVENTION

The present invention relates, generally, to compositions comprising porous monoliths, such as continuous networks comprising linked aggregates comprising particles, or materials comprising inorganic oxides and/or carbonaceous material having at least one organic compound attached to the surface of the monolith. These monoliths can be used as membranes or chromatography supports for molecular or biomolecular separations.

### BACKGROUND OF THE INVENTION

Fumed particles such as carbon black, and fumed metal oxides are particulate materials approximating spherical primary particles on the order of 10's of nanometers. These particles are fused together into branched aggregates having dimensions on the order of 100's of nanometers. FIG. 1 schematically shows aggregates of the spherical primary particles.

These particulate materials are useful in various applications as is. Their uses include highly dispersing the particles into other media such as polymers (e.g. rubber), liquids (e.g. inks) or solid systems (e.g. flowing powders). These fine particle powders are densified or pelleted, for handling and transporting purposes. These materials, however, offer porosities that may be too small for many applications.

There is much activity in generating materials comprising carbon and/or metal oxides having larger pore sizes and high surface areas.

Some porous materials have been made via sol gel chemistry. Sol gel technology, however, has not advanced enough to encompass a wide range of material types.

Polymer matrices have been used to make materials with high surface area and porosity. It can be difficult to make larger polymer matrices because heat is produced during polymerization. The heat can generate temperature gradients through the forming matrix resulting in spatial heterogeneity of the resulting matrix.

Sintering of metals can produce porous metal materials. These materials are generally not available in the surface areas, pore sizes, and void volumes in the range anticipated for the nanoporous networks.

As noted above, fine particles can be pelletized or densified. This process is usually performed by tumbling or agitating the powder in a drum either dry, with a liquid (e.g. water), or with liquid and a binder. When a liquid is used, the agglomerated particles or pellets are then dried. This approach is limited, however, to the formation of small pellets (order of mm), which do not have strength or high controlled void volume.

Accordingly, there remains a continuing need to develop materials having high surface areas and porosities.

Zirconia, carbon and titania are fairly robust materials and are good candidates as supports for separations. These materials are much harder than other supports and are resistant to a wide range of acids and bases. They are also resistant to degradation or deformation over a large temperature range. Functionalizing or passivating these materials, and other inorganic porous supports, has proved challenging, however. For some applications, functionalization is possible by applying a carbon coating on the surface and subsequently functionalizing the carbon surface. There are also some known examples where these supports have been derivatized in particulate form.

Accordingly, there remains a need for robust support materials that can be derivatized with a variety of organic groups and ligands, useful, for example, in the separation of small molecules and biomolecules.

### SUMMARY OF THE INVENTION

One aspect of the present invention provides a composition comprising carbonaceous material and/or an inorganic oxide comprising aggregates comprising particles, and discrete linkers connecting the aggregates, wherein the composition is porous.

Another aspect of the present invention provides a composition comprising carbonaceous material and/or an inorganic oxide comprising particles having a mean diameter of at least 5 nm, and discrete linkers connecting the particles, wherein the composition is porous.

Another aspect of the present invention provides a method comprising providing carbonaceous material and/or an inorganic oxide comprising aggregates comprising particles, and combining discrete linkers with the aggregates. The method further comprises forming a continuous network comprising the aggregates.

Another aspect of the present invention provides a composition comprising a porous monolith comprising a material chosen from carbonaceous material or an inorganic oxide. The composition further comprises at least one organic compound attached to the surface of the monolith.

Another aspect of the present invention provides a composition comprising a material, the surface of the material being bonded to an organic group having a formula chosen from:

—Ar—(CH₂)ₘ(O(CH₂)_{y})ₙNR₂ and Ar—(CH₂)ₘ(O(CH₂)_{y})ₙN⁺R₃, wherein Ar is an aromatic group; m, y, and n are independently chosen from zero and an integer; and R is chosen from hydrogen and alkyls;

—Ar—C(O)(O(CH₂)_{y})ₙNR₂ and Ar—C(O)(O(CH₂)_{y})ₙN⁺R₃, wherein Ar is an aromatic group; y and n are independently chosen from zero and an integer; and R is chosen from hydrogen and alkyls;

—Ar—C(O)NH(CH₂)ₘ(O(CH₂)_{y})ₙNR₂ and Ar—C(O)NH(CH₂)ₘ(O(CH₂)_{y})ₙN⁺R₃, wherein Ar is an aromatic group; m, y, and n are independently chosen from zero and an integer; and R is chosen from hydrogen and alkyls;

—Ar—(CH₂)ₘ(O(CH₂)_{y})ₙCOOH, wherein Ar is an aromatic group; m, y, and n are independently chosen from zero and an integer; and R is chosen from hydrogen and alkyls;

—Ar—(CH₂)ₘ(O(CH₂)_{y})ₙSO₃H, wherein Ar is an aromatic group, and m, y, and n are independently chosen from zero and an integer; and

—Ar—(CH₂)ₘ(O(CH₂)_{y})ₙSO₃H, wherein Ar is an aromatic group, and m, y, and n are independently chosen from zero and an integer.

It is to be understood that both the foregoing general description and the following detailed description are exemplary and explanatory only and are not restrictive of the invention, as claimed.

### BRIEF DESCRIPTION OF THE DRAWINGS

FIG. 1 is a two-dimensional schematic of aggregates, showing particles fused to form the aggregates; and

FIG. 2 is a two-dimensional schematic showing a network of aggregates.

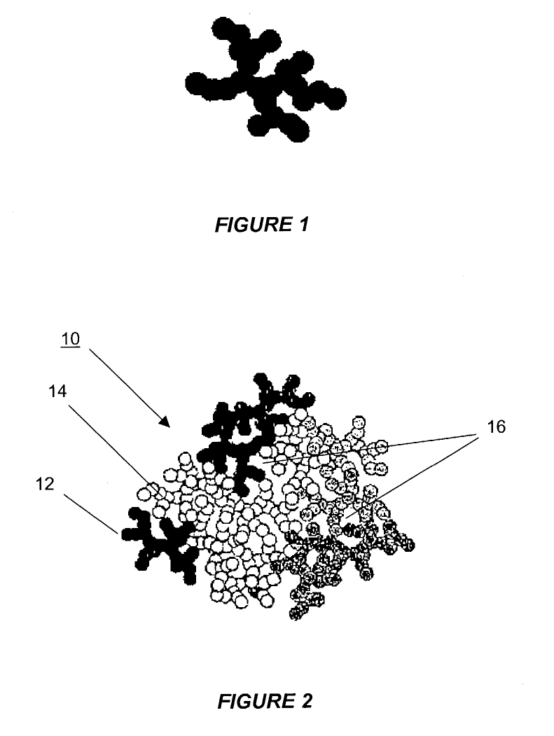

### DESCRIPTION OF THE EMBODIMENTS

The present invention relates to novel porous materials. In one aspect, the porous materials are prepared by converting particulate materials and aggregates into macroscopic forms, such as continuous networks. These networks can be useful for applications benefiting from the chemical composition of the particulate materials (e.g. pure silica) and the macro physical form of the formed material, such as size, shape, controlled voids, surface area and durability.

One aspect of the present invention provides a porous composition comprising aggregates comprising particles, where discrete linkers connect the aggregates. In one embodiment, the composition comprises a continuous network of the aggregates. Thus, this aspect can provide a porous composition where the pores can be varied depending on the composition, size, and shape of the aggregates and the linkers.

FIG. 2 is a two-dimensional schematic of one embodiment of the invention. FIG. 2 depicts composition 10 comprising a network of individual aggregates, where each aggregate in itself comprises a plurality of particles. Certain discrete aggregates are indicated in varying shades ranging from black shade to darker shade to white, to illustrate the attachment of the aggregates with each other. For example, aggregate 12 is indicated in black shade.

FIG. 2 shows a collection of these discrete aggregates joined to each other via a discrete linker. The linker material is not visible in FIG. 2. “Discrete linker” refers to a substance that on its own is capable of connecting at least two aggregates to each other. For example, discrete linkers are distinguished from a single adhesive mass that envelops, binds, or adsorbs the aggregates to form a continuous network. Generally, the discrete linkers will not contact each other, although some inherent contact, depending on the linker type, may occur.

Depending on the number of linkers per aggregates, the linkers may attach to at least two aggregates, only one aggregate, or none of the aggregates. Thus, the linkers can have at least one of three functions in the network, (i) link at least two aggregates, (ii) attach to one aggregate, having at least one unused site (“unused linker site”) capable of linking, cross-linking, further reaction, or derivatization, or (iii) link none of the aggregates, and remain unused (“unused linker”). The unused linker can subsequently be used for linking, cross-linking, further reaction, or derivatization. In one embodiment, the linker types (ii) and (iii) can be used modify, i.e., derivatize the surface of the aggregate, as discussed herein.

In one embodiment, the discrete linker can be a molecule covalently bonding, ionically bonding, or adsorbing at least two aggregates, i.e., at least two previously separate aggregates. In another embodiment, the discrete linker can be an adhesive substance present at “touch points” between at least two aggregates. The composition can comprise one or more different types of discrete linkers, whether they be molecular or adhesive, and one of ordinary skill in the art can readily appreciate that various combinations of discrete linkers are possible.

The aggregates in the porous composition can comprise particles that are porous or nonporous. Regardless of the porosity of the particles, the aggregates prior to forming the composition can have pores arising from the fusion of particles. The resulting composition can be porous in part due to the pores of the individual aggregates, i.e., those pores defined by the particle surfaces. Referring to FIG. 2, pore 14 exemplifies a pore within an individual aggregate. In one embodiment, each aggregate has pores defined by the particles surfaces, where the pores have a mean diameter ranging from 5 nm to 200 nm, such as a mean diameter ranging from 5 nm to 100 nm, or a mean diameter ranging from 10 nm to 100 nm. In one embodiment, at least 50% of the pores in the individual aggregates have a diameter ranging from 5 nm to 200 nm, such as a diameter ranging from 5 nm to 100 nm, or ranging from 10 nm to 100 nm. In another embodiment, at least 70% of the pores, e.g., at least 80% or at least 90% of the pores have a diameter ranging from 5 nm to 200 nm, such as a diameter ranging from 5 nm to 100 nm, or ranging from 10 nm to 100 nm.

In one embodiment, the porous composition has pores arising from the fusion of the aggregates. In this embodiment, the composition has pores defined by the aggregates surfaces. Referring to FIG. 2, pores 16 are those pores created by different aggregate surfaces. In one embodiment, these pores have a mean diameter ranging from 25 nm to 10 μm, such as a mean diameter ranging from 25 nm to 3 μm, or ranging from 25 nm to 1 μm, or ranging from 25 nm to 500 nm. In another embodiment, at least 50% of the pores by volume have a diameter ranging from 25 nm to 10 μm, such as a mean diameter ranging from 25 nm to 3 μm, or ranging from 25 nm to 1 μm, or ranging from 25 nm to 500 nm. In yet another embodiment, at least 70% of the pores, e.g., at least 80% or at least 90% of the pores, have a diameter ranging from 25 nm to 10 μm, such as a mean diameter ranging from 25 nm to 3 μm, or ranging from 25 nm to 1 μm, or ranging from 25 nm to 500 nm.

In one embodiment, the particles are porous and the particle pores contribute to the porosity of the composition.

In one embodiment, the pores or voids created in the composition formed by linking these aggregates can provide channels in a three-dimensional network. The resulting network can comprise tortuous flow through channels. The channels can have any of the diameters of the pores, as described above.

The composition can have an open structure with a significant void volume. In one embodiment, the composition has a void volume ranging from 40% to 95% relative to the total volume of the composition. In another embodiment, the composition has a void volume ranging from 50% to 95%, such as void volume ranging from 50% to 90%, from 75% to 95%, or from 75% to 90%, relative to the total volume of the composition.

In one embodiment, the composition has a surface area ranging from 10 to 300 m² per mL of the composition, such as surface areas ranging from 100 to 300 m² per mL of the composition, or from 10 to 100 m² per mL of the composition.

The particles can comprise a variety of materials, so long as they have sufficient structural strength to maintain the integrity of the resulting composition. In one embodiment, the particles comprise at least one substance chosen from ceramics, carbonaceous material, metals, and polymers. “At least one” as used herein refers to “one or more,” and thus encompasses individual components as well as mixtures/combinations.

In one embodiment, the particles comprise ceramics chosen from oxides, nitrides, carbides, selenides, arsenides, and borides. “Chosen from” as used herein also encompasses individual components as well as mixtures/combinations.

Exemplary oxides include those chosen from silica, alumina, ceria, titania, zirconia, boria, chromia, tin oxide, and nickel oxide. The oxides can also include mixed oxides, such as aluminosilicates (e.g., mica, kaolins, zeolites), or any other mixed oxides, such as those chosen from silica, alumina, ceria, titania, zirconia, boria, chromia, tin oxide, and nickel oxide.

The oxide may be produced by any technique known to those skilled in the art. For example, the production of a fumed inorganic oxide is a well-documented process involving the hydrolysis of suitable feed stock vapor, such as aluminum chloride for a fumed alumina, and silicon tetrachloride for fumed silica, in a flame of hydrogen and oxygen. Molten particles of roughly spherical shape are formed in the combustion process, the diameters of which are varied through process parameters.

Precipitated inorganic oxides may be manufactured by utilizing conventional techniques. For example, precipitated inorganic oxides may be formed by the coagulation of the desired particles from an aqueous medium under the influence of high salt concentrations, acids or other coagulants. The particles can be filtered, washed, dried and separated from residues of other reaction products by conventional techniques known to those skilled in the art.

Exemplary metals include those chosen from gold, silver, platinum, iron, nickel, and palladium. Alloys can also be used.

Exemplary forms of carbonaceous material include those chosen from activated carbon, carbon black, fumed carbon black, graphite, or other carbonaceous material obtained by the pyrolysis of cellulosic, fuel oil, polymeric, or other precursors. Additional examples, include but are not limited to, carbon fibers, carbon cloth, vitreous carbon, carbon aerogels, pyrolized ion exchange resins, pyrolized polymer resins, mesoporous carbon microbeads, pelleted carbon powder, nanotubes (e.g., single-walled, double-walled, and multi-walled), buckyballs, fullerenes, vitreous carbon, carbon allotropes, and carbon obtained by chemical vapor deposition (CVD), silicon-treated carbon black, silica-coated carbon black, metal-treated carbon black, densified carbon black, carbon clad silica, alumina, and ceria particles, and combinations thereof or activated versions thereof. The carbonaceous material can also be a waste product or by-product of carbonaceous material obtained by pyrolysis, including carbonized polymeric particles (e.g., polydivinylbenzene based chromatographic particles, or sulfonated polydivinylbenzene/polystyrene particles). Preferably, the carbonaceous material is activated carbon or carbon black capable of adsorbing an adsorbate. Commercial examples of carbon black include, but are not limited to, Black Pearls® 2000 carbon black, Black Pearls® 430 carbon black, Black Pearls® 900 carbon black, and Black Pearls® 120 carbon black, all available from Cabot Corporation. Commercial examples of activated carbon include Darco S51, available from Norit; Sorbonorit 3, available from Norit; Ambersorb adsorbent (available from Rohm and Haas); Hypercarb carbon particle (available from ThermoHyperSil); TosoHaas carbon materials; and BPL activated carbon from Calgon. The carbonaceous material modified by the procedures described herein may be a microporous or mesoporous activated carbon in granular or pellet form; a carbon black of different structures in fluffy or pelleted form; or any other carbonaceous material whose applicability to this invention is apparent to those skilled in the art, such as carbon fibers or carbon cloth. The choice of carbonaceous material used eventually depends on a variety of different factors, including the application for which it is intended. Each of these types of carbonaceous material has the ability to adsorb at least one adsorbate. A variety of BET surface areas, micropore volumes, and total pore volumes are available depending on the desired end use of the carbonaceous material.

Other preferred carbonaceous materials include, but are not limited to, material obtained by the compaction of small carbon particles and other finely divided forms of carbon as long as the carbon has the ability to adsorb at least one adsorbate and is capable of being chemically modified in accordance with the present invention.

Also, for purposes of the present invention, the carbonaceous material can be an aggregate comprising a carbon phase and a silicon-containing species phase. A description of this aggregate as well as means of making this aggregate is described in PCT Publication No. WO 96/37547 and WO 98/47971 as well as U.S. Pat. Nos. 5,830,930; 5,869,550; 5,877,238; 5,919,841; 5,948,835; and 5,977,213. All of these patents and publications are hereby incorporated in their entireties herein by reference.

The carbonaceous material for purposes of the present invention, can also be an aggregate comprising a carbon phase and metal-containing species phase where the metal-containing species phase can be a variety of different metals such as magnesium, calcium, titanium, vanadium, cobalt, nickel, zirconium, tin, antimony, chromium, neodymium, lead, tellurium, barium, cesium, iron, molybdenum, aluminum, and zinc, and mixtures thereof. The aggregate comprising the carbon phase and a metal-containing species phase is described in U.S. Pat. No. 6,017,980, also hereby incorporated in its entirety herein by reference.

Also, for purposes of the present invention, the carbonaceous material includes a silica-coated carbon black, such as that described in U.S. Pat. No. 5,916,934 and PCT Publication No. WO 96/37547, published Nov. 28, 1996, also hereby incorporated in their entirety herein by reference.

The carbonaceous material described above is then modified by the attachment of an organic group to the carbonaceous material. Preferred processes for attaching an organic group to a carbonaceous material and examples or organic groups are described in detail in U.S. Pat. Nos. 5,554,739; 5,559,169; 5,571,311; 5,575,845; 5,630,868; 5,672,198; 5,698,016; 5,837,045; 5,922,118; 5,968,243; 6,042,643; 5,900,029; 5,955,232; 5,895,522; 5,885,335; 5,851,280; 5,803,959; 5,713,988; and 5,707,432; and International Patent Publication Nos. WO 97/47691; WO 99/23174; WO 99/31175; WO 99/51690; WO 99/63007; and WO 00/22051; all incorporated in their entirety by reference herein. These processes can be preferably used in preparing the modified carbon adsorbents of the present invention and permit the attachment of an organic group to the carbonaceous material via a chemical reaction. As indicated above, the organic group attached to the carbonaceous material is one preferably capable of increasing the adsorption capacity and/or selectivity of the carbonaceous material and/or enhancing the resolution of solute peaks in chromatographic separations.

As indicated above, once the desired separation technique is chosen and the particular chemical species preferably known, a particular functional group or multiple functional groups can be chosen to be attached onto the carbonaceous material in order to accomplish the selectivity needed to conduct the separation process. For instance, as set forth in Garcia et al., heparin is used in the separation of lipoproteins, accordingly, heparin can be attached onto carbonaceous material in order to accomplish the desired separation. Similarly, when cationic exchange processes are needed, a sulfonic acid, for instance, can be attached on a carbonaceous material and when anionic exchanges are needed, a quaternary amine can be attached onto the carbonaceous material. Thus, with the present invention, and the knowledge possessed by one skilled in the art, separation techniques can be conducted using modified carbonaceous material to achieve the selectivity desired.

Besides carbonaceous materials, the metal oxides that are not carbon cladded can be used in combination or alternatively. Examples include, but are not limited to, alumina, ceria, titania, zirconia, boria, chromia, tin oxide, and nickel oxide., and the like.

Exemplary polymers include those chosen from those having a T_{g} of at least 100° C.

The discrete linkers can encompass a wide range of commercially available natural and synthetic products. The discrete linkers can be chosen from organic molecules, inorganic molecules, polymers, and biopolymers. In one embodiment, the linker is capable of cross-linking with itself.

Exemplary organic molecules that can function as discrete linkers are chosen from electrophiles, nucleophiles, molecules that participate in cycloaddition or electrocyclic bond forming reactions, and molecules that form non-covalent interactions.

(1) Electrophilic linkers. A non-limiting list of electrophiles includes:

carboxylic acid and esters;

carboxylic acid halides such as chlorides or fluorides, also acyl azides and anhydrides;

activated esters of carboxylic acids such as pentafluorophenol, N-hydroxysuccinamide and hydroxybenzotriazole;

sulfonyl halides, sulfonyl azides and sulfonyl isocyanates;

isocyanates and isothiocyanates and blocked forms of isocyanates, such as malonate adducts;

ketones and aldehydes;

amides, hydroxymethylamides, ureas and hydroxymethylureas, melamine-formaldehyde adducts and urea-formaldehyde adducts;

imides;

imines;

linear or cyclic α,β-Unsaturated ketones, aldehydes, nitriles, sulphones, sulfoxides, phosphonates, etc and precursors to these as a result of β-elimination or other fragmentation reaction;

alkylating agents, such as alkyl halides, epoxides, thioepoxides, aziridines, mono and disubstituted halo-triazines or pyrimidines, oxazolines, alkyl or cyclic sulfonates, sulfates and phosphates, etc.; and

aromatic compounds that undergo addition-elimination reactions, such as o-fluoronitrobenzene.

(2) Nucleophilic linkers. A non-limiting list includes:

amines, hydroxylamines, or hydrazines;

alcohols or alcoholates;

phenols or phenolates;

thiols or thiolates;

carboxylates, and salts of thioacids, xanthates and cyanurates;

amides, hydrazides, sulfonamides and acylated sulfonamides;

oximes;

carbanions and their precursors, such as malonates, cyanoacetate and α-cyanosulphones;

imides, such as phthalimide and succinimide; and

electron rich aromatic rings.

(3) Linkers that take part in cycloaddition or electrocyclic bond forming reactions. Cycloaddition reactions occur between dienes and dieneophiles. Thus, the linkers can be dienes that are either linear or cyclic. Exemplary dienes include 1,3-butadienes, cyclopentadienes, furans and oxazoles. Alternatively the linkers can be dienophiles, where exemplary dienophiles include α,β-unsaturated ketones, aldehydes, nitriles, sulphones and groups containing electron deficient double bonds such as maleamide and esters of maleic acid. Electrocyclic reactions include the Ene reaction (as described in J. March, Advanced Organic Chemistry, 2ed., 1977, p. 726) where a dieneophile reacts with an olefin bearing at least one allylic hydrogen (the ‘ene’). Examples of such olefinic groups include allyl alcohols and ethers, α-olefins and allyl aromatics. Alternatively, the linker can be an olefin group that reacts with a dienophile.

(4) Linkers that form strong associations through non-covalent interactions such as hydrogen bonding, salt bridges, and hydrophobic interactions. Examples of groups capable of forming strong hydrogen bonds include aminotriazines, cyanurates, pyrimidines, uracils and the like. Salt bridges may form between groups of opposite charge, for example sulphonate salts and salts of amines. Examples of strong hydrophobic interactions include fatty acid esters or hydrophobic polymers in aqueous media.

Linkers may also form bonds directly with an inorganic oxide surface that has reactive sites. In one example, reaction with the surface of an inorganic oxide, or aggregate comprising particulate inorganic oxides, can be accomplished by the hydrolysis of a siloxane, e.g., RₙSi(OR′)₄₋ₙ, where n<4, and R is independently any of organic groups (1) to (4) listed above and and R′ is independently an alkl group. The hydrolysis can be performed in the presence of the inorganic oxide to at least partially cover the surface.

The linkers can be selected from, but not limited to, organic compounds and polymers such as polyorganosiloxanes, commonly referred to as silicones. Other organic materials, whether monomeric, polymeric, or elastomeric include, but are not limited to, acrylics, alkyds, epoxies, formaldehydes, glycols, polyamides, polyesters, polyethers, polyimides, polyolefins, polyols, polysulfides, polyvinyl acetate, polyurethanes, polyalkylene glycols, and mixtures thereof, all of which are commercially available and are produced utilizing techniques known to those skilled in the art. The polyorganosiloxanes may include various functional groups, for example methyl, phenyl, vinyl, trifluoro, chloro and combinations thereof. Common polyorganosiloxanes include polydimethylsiloxanes, dimethylphenylmethylpolysiloxane or trifluoropropylmethylsiloxane. In addition the polyorganosiloxanes may be of a branched, cyclic, linear, or oligomeric nature and contain various functionalities including, for example: alkenyl groups; halo groups; hydroxy groups; carboxy groups; cyano groups; epoxy groups; amino groups; and combinations thereof. Nonlimiting examples of such resins are available commercially under the tradenames D.E.R.® Epoxy Resin, Drakeol® Mineral Oil, Polylite® Alkyd Resin, Epone® Epoxy Resin, and DC200® Silicone Oil.

The polymer can be a thermoplastic polymeric group or a thermosetting polymeric group. The polymeric group can be a random polymer, alternating polymer, graft polymer, block polymer, star-like polymer, and/or comb-like polymer. In addition, the polymeric group can be a homopolymer, copolymer, terpolymer, and/or a polymer containing any number of different repeating units. Examples of polymeric groups include, but are not limited to, polycarbonates, polyethers, polyesters, polyacrylates, polymethacrylates, polystyrenes, polyamines, and polyolefins. The polymeric group can comprise a phenylether or bisphenyl ether and a substituted propanediyl group. For example, the polymeric group may be a polymer prepared from epoxy bisphenol-A, oligomers of epoxy bisphenol-A, or epoxy novolac.

The polymer can be a naturally occurring polymer, such as gelatins, starches, polysaccharides, lignosulfonates, and derivatives thereof. Exemplary polysaccharides include starch, agarose, cellulose, dextran, and others.

In one embodiment, where the aggregate comprises carbonaceous material, the linker can be chosen from homopolymers, copolymers and graft polymers of ethylene, elastomers of natural rubber, polybutadiene, polyisoprene, random styrene butadiene rubber, polychloroprene, nitrile rubbers, ethylene propylene copolymers and terpolymers, homopolymers and copolymers of styrene, linear and branched polyether or polyester polyols, crystalline and amorphous polyesters and polyamides, alkyd resins, rosin esters, rosin esters, hydrocarbon resins produced from thermal or Friedal Crafts polymerization of cyclic diene monomers, ethylene/silane copolymers, ethylene/α-olefin/diene terpolymers, and mixtures thereof.

In one embodiment, the biopolymers are chosen from proteins, nucleic acids, and polypeptides. Exemplary proteins include protein A, protein G, and bovine serum albumin (BSA).

The linkages between aggregates may be accomplished by reacting an electrophilic particle or aggregate with a linker containing the appropriate complementary nucleophilic groups (or vice versa). In the case of aggregates having groups that bond by cycloaddition or electrocyclic reactions, the linkages can result from the reaction of an aggregate comprising a diene (or ‘ene’) with a linker comprising the complementary dienophile (or vice versa). The linkages may also result by mixing and reacting aggregates with complementary chemistries.

For inorganic or mixed inorganic-organic linkers, the oxide containing aggregate or particle can be reacted with, for example, a siloxane or any other oxide-reactive substance to form the stable network.

The strongly associating/non-covalent networks of particles can be formed spontaneously by mixing the components and then changing the character of the suspending medium such that the attraction between the particles overcomes any dispersion stabilizing forces. The components may be a mixture of complementary particles or of particles and some other material comprising the complementary group.

Another aspect of the invention provides a porous composition comprising discrete linkers connecting individual particles. In this aspect, aggregates need not be formed. The particles can have a diameter of at least 5 nm, such as a diameter of at least 10 nm. The particles can be porous or nonporous. Any particle or linker as described herein can be used according to this aspect. The particle surface or linker can be modified, i.e., derivatized, as described herein.

Another aspect of the present invention provides a method of preparing a composition. The method comprises providing aggregates comprising particles. The aggregates can be any aggregate as described herein. The method further comprises, in no specified order, combining discrete linkers with the aggregates and forming a continuous network comprising the aggregates.

In one embodiment, the aggregates are provided in a liquid medium, such as by dispersing the aggregates in the liquid medium. In selecting a desired aggregates and liquid medium combination, the nature of surface chemistry of particles may be considered. In one embodiment, the particle surface is chosen to be non-complimentary with or repel the liquid, i.e., the particle is “lyophobic.” For example, carbon particles are non-complimentary with water due to their hydrophobic surfaces. Aggregates comprising carbon particles, when dispersed in water, are attracted to each other and can form a continuous network in the water even without the presence of the linkers. This situation presents an example of where forming the continuous network can precede combination of the linkers with the aggregates such that the continuous network comprises aggregates free of the discrete linkers.

In one embodiment, the particles are lyophilic, and the method further comprises treating the particles to render them lyophobic. For example, the particle can be surface-modified to provide a certain hydrophilicity or hydrophobicity, to render the aggregates lyophobic with the liquid medium, if desired. In one embodiment, “surface” refers to the accessible surface. For example, the inner surface of the pores can also be derivatized if the reagents have the size, or the pores have the pathway, to access these sites.

When dispersed in a liquid medium that is not compatible with the aggregates, the aggregates can form a gel state, i.e., “floc network,” comprising a continuous network that maximizes particle-to-particle contact and reduces particle surface to liquid medium contact. The floc network can be a high viscosity state. The ability to form the microscopic features, such as porosity and channel size, can depend on a number of factors, including particulate primary particle size, aggregate size and structure, particle concentration in medium, level of shear employed, and solid/liquid interfacial energy. The floc network can be formed with as little as 5-10% by volume of particulate material in the network. This lower limit can be achieved, for example, by use of high surface area and high structure aggregates. In one embodiment, the particles are present in the floc network in an amount ranging from 0.5% to 50% by volume relative to the total volume of the composition. In another embodiment, the particles are present in the floc network in an amount ranging from 5% to 50% by volume relative to the total volume of the composition.

In one embodiment, the aggregates can be dispersed in the liquid medium by shearing. For example, the mixture can be severely sheared to separate agglomerates of aggregates and set up a particle floc network. In one embodiment, the mixing take place under high shear conditions, i.e., subject to an intense shear for low shear residence times. For instance, the shearing can be carried out with a homogenizer or a high velocity nozzle.

Because the floc network can be produced in a high viscosity state, the floc network can be readily shaped into a desired form, for example, by injection molding. In another example, the network can be formed into any one of a micron scale channel, a mold for a cm scale form, or a chromatography column, while maintaining the floc network. In one embodiment, the floc network can be revitalized via, for instance, via sonification, once the mixture is in its desired form.

The composition can be surface-modified, as understood by one of ordinary skill in the art. In one embodiment, the surface of the particles, or the surface of the aggregates comprising particles, are derivatized. In another embodiment, the surface of the composition can be modified by derivatizing the unused linkers or unused linker sites. For example, the composition can be chemically treated by attaching a sufficient concentration of ligands (or linker) to the surface, which can be triggered for cross-linking and thus joining the aggregates, and any ligand or excess linker material can be further derivatized. In one embodiment, where the aggregates are to be dispersed in a liquid medium, the ligands (or unused linkers or unused linker sites) can retain or provide lyophobicity between the aggregate/particle surface and the liquid medium. Alternatively, the chemical ligands on the surface (or unused linkers or unused linker sites) can be capable of further modification or derivatization at any stage of the monolith forming process or post-formation.

In one embodiment, the surface is modified with inorganic groups, such as those used as ion exchange groups. Exemplary inorganic groups include SO₃⁻ and NH₄⁺.

In one embodiment, the combining comprises binding the discrete linkers with the aggregates. The binding can comprise covalently bonding or adsorbing the linkers with the aggregates. Alternatively, the binding can comprise noncovalently interacting the linkers with the aggregates.

The binding can result in the linkers simultaneously or near simultaneously connecting the aggregates with each other. For example, where the linkers have at least two sites that are capable of binding with the aggregate, a continuous network comprising the linkers and the binders may spontaneously form. In another example, the linker may have only one binding site but may have at least one reactive site capable of reacting with a reactive site on another linker, such as in a self-condensation reaction. Schematic examples of this reaction are shown in the following equations, where A=aggregate, X=reactive group or group capable of participating in noncovalent interactions, E=electrophile, Nu=nucleophile, I=intermediate group or atom, where I can be a reactive group or spacer.

A+A+-X-→A-X-A (1)

A-E+Nu-A→A-E-Nu-A (2)

2A-E+Nu-I-Nu→A-E-Nu-I-Nu-E-A (3)

2A-Nu+E-I-E→A-Nu-E-I-E-Nu-A (4)

In another embodiment, the method can also comprise triggering the linkers to bind the discrete aggregates together. When the particle surface ligands or linker material binds or cross-links, a rigid, sustainable porous composition can be formed having tortuous flow through channels. Depending on the linker employed, the cross-linking process may be initiated with an external stimulus, such as heat, ultrasound, radiation, pH change, or addition of a chemical reagent. The cross-linking can occur after the gelled state has been molded. This embodiment can be shown schematically in the following equations, where (*) indicates activated or triggered linker:

2A+2-X+external stimulus→A-X*+*X-A (5a)

A-X*+*X-A→A-X-X-A (5b)

In one embodiment, the linker may not directly bind with the aggregate but through an intermediate group, such as an atom, a molecule or any other material. For example, the linker or the aggregate surface can be derivatized with the intermediate material, which then can allow binding between the linker and the aggregate. The following equations show this embodiment schematically, where I=intermediate group, and X and X′ can be the same or different.

2A+-I-X+-I-X′→A-I-X+X′-I-A (6a)

A-I-X+X′-I-A→A-I-I-A+X+X′ (6b)

2A-I+X+X′→A-I-X+X′-I-A (7a)

A-I-X+X′-I-A→A-I-I-A+X+X′ (7b)

2A-I+X→A-I-X-I-A (8)

The network can be formed either simultaneously or with an external stimulus.

The properties of the composition can be controlled by proper selection of the aggregate, the primary particle size, structure, and concentration. For instance, aggregates having small primary particles and a “tight” structure (where “tight” is contrasted with an open, more branched, or extended structure) generally produce smaller dimensional channels. Lower solids concentration solids can increase open cross section. The chemistry of the nanochannel solid can be modified to support the intended function.

The porous continuous networks can be used for a number of applications including, but are not limited to:

1. Chromatographic supports. These can take the form of monolithic chromatographic supports or chromatographic support beads, where each bead comprises a monolith as described herein. Grinding the solid network to a desired size can produce the beads.

2. Supports for solid phase chemistry or solid phase reagents and scavengers

3. High surface area packing for chemical reactors, for example, an immobilized enzyme reactor. In this case the porous network monolith would be formed and the active enzyme immobilized on the network by appropriate chemical linking (enzyme might be linked to monolith after monolith formation or to the fine particles prior to forming of the monolith).

4. Support for heterogeneous catalysis.

5. Microfluidics elements such as chromatography support, mixing element, catalytic support. The composition can be formed in-situ into very small channels or forms, such as microfluidic devices with dimensions of 10's to 100's of microns.

The compositions can comprise high surface area materials, for maximizing convective material transport and minimizing diffusional transport limitations. The porous network properties, e.g. surface area, void volume, channel or pore size and size distribution, can be controlled by varying: 1) particle size; 2) particle shape, i.e., morphology; and 3) slurry solids concentration.

Another embodiment of the present invention provides a membrane comprising the porous composition described herein, formed into a thin film. The membrane can comprise aggregates linked to each other through discrete linkers, as described herein.

In one embodiment, the linker is capable of changing physical properties, such as conformation, shape, and length, in response to at least one environmental condition, such as pH, electric field, magnetic field, temperature, solvent, ionic strength, rheology, shear, and light. Alternatively stated, the linker is responsive to the at least one environmental condition. Thus, by changing the environmental condition, the properties of the composition, such as pore size, binding strength, binding capability, flexibility, and linker conformation can be altered and controlled.

For example, if the linker was shape and/or size sensitive to pH, then increasing the pH, for example, may result in the linker extending to create a more open matrix. This network, when cast in a thin sheet, can have an application as a “tunable membrane” for filtration, and/or designed for easy cleaning. In another example, the network can be injection molded into a chromatography column shell under conditions in which the linkers are in a contracted state. The environment for storage and use can then convert the linkers to their extended state. Thus the network can expand sufficiently to provide a tight fit between the monolithic media and the chromatography column wall; this tight fit can prevent flow along, for example, a tube wall, where the network fitted into a tube used as a chromatography column. In this example, the ability to expand to fit the tube can provide even flow across the column cross section. In another example, the linker can be conformation-dependent on upon application of an electric field. In this configuration, the matrix properties, e.g., void volume and/or size, could be varied by a voltage setting.

Other applications for this general material can be envisioned depending upon the form of the matrix, cross-link molecules employed, and “motive” factor or environmental condition employed. The concept fits with the overall push for “smart” membranes or materials that can respond to change and thus increase flexibility/function in use. Thus, the function can be varied or tuned via manipulation at the nano scale.

Moreover, the monolith can be used as a membrane that can be prepared for adsorption. Membrane adsorption can be used, for example, in protein purification. Membrane adsorption can be a competitive step to polishing chromatography (last of chromatographic steps in protein purification) in which trace impurities such as DNA, endotoxins, and host proteins, which are present in low concentration, are removed. When chromatography is used for polishing, the chromatographic column and volume of media can be relatively large (for example 100 liters). The size of the column is generally not dictated by the required adsorption capacity (impurities in low concentration), but rather the column diameter needed to handle the liquid flow rate and the column depth required to assure an even flow distribution across the column. In membrane adsorption, the chromatography column can be replaced by a polymer membrane module; the membrane can be treated to provide ion exchange or other selective retention functionality. The membrane volume can supply sufficient capacity and even flow distribution as provided by the tight membrane pore size distribution. With membrane adsorption the illustrative 100 liter chromatography column can be replaced with a 0.5-1 liter membrane module.

In one embodiment, a thin section of cross-linked particle matrix can function as the substrate “membrane”. This membrane can be surfaced treated to provide the ion exchange or other surface chemistry required to effect the adsorption. Even flow distribution can be assured by the combination of the multistage and relatively regular size irregular flow channels created by the particle matrix.

In another embodiment, the combining further comprises combining the discrete linkers, the aggregates, and removable substances. In this embodiment, the removable substances can act as a template for the formation of larger voids or channels. These substances can have any desired shape or size, and can be particles, rods, fibers, etc. In one embodiment, the removable substances have a dimension ranging from 500 nm to the maximum dimension of the network. For example, the substance can be a rod or fiber that can template a channel spanning the length of the network. When combined, the gelled state can comprise the linkers, aggregates, and removable substances. The removable substances can be, but are not necessarily part of the resulting continuous network.

Exemplary removable substances include silica, waxes, biodegradable substances, thermally degradable substances, photodegradable substances, carbon, and other organic materials capable of being removed.

In one embodiment, the removable substances can be removed by a process chosen from etching, leaching, solubilizing, and burning, i.e., the material can be burned off. For example, where the removable substance is silica, the network can be exposed to an etchant, such as a strong base solution (e.g. a 0.1 N NaOH aqueous solution) to remove the silica. Alternatively, the network can be exposed to a solvent that can dissolve away the removable substance.

In one embodiment, the removable substance can be included in the aggregate. A examples of such aggregates include, but are not limited to, aggregates comprising a carbon phase and a silicon-containing species phase and aggregates comprising a carbon phase and a metal-containing phase, which are described.

Removing the removable substance from the network results in the formation of voids. In one embodiment, the voids have a mean diameter ranging from 500 nm to 50 μm, such as a mean diameter ranging from 500 nm to 20 μm, or a mean diameter ranging from 1 μm to 20 μm. The resulting continuous network can have at least three types of voids: (1) a first fraction having pores defined by the particle surfaces (i.e., pores of the individual aggregates); (2) a second fraction having pores defined by the aggregate surfaces (i.e., pores arising from linking the aggregates); and (3) a third fraction having pores arising from the templating process. Additionally, if the network comprised porous particles, the pores of the particles themselves can contribute to the overall porosity of the network.

Another aspect of the present invention relates to the surface modification of porous monoliths having carbonaceous material or inorganic oxide. One application for this composition is the selective separations of small molecules, enantiomers and/or biomolecules.

One aspect of the present invention comprises a composition comprising a porous monolith. A “monolith” as used herein refers to a unitary structure, as opposed to a collection of isolated particles. In the area of separations or chromatography, monolithic chromatography supports can be advantageous over a column of packed particles. Resolution of the separation improves as the density of the packed particles increases. Usually, however, flaws or gaps occur when packing particulate supports, thereby compromising chromatographic performance. A porous monolith, in contrast, bypasses the packing step by providing a single unitary support. Thus, the gaps and channels arising from a poorly packed column are eliminated.

In one embodiment, the porous monolith comprises a material chosen from carbonaceous material and inorganic oxide.

In one embodiment, a porous monolith comprising a material chosen from carbonaceous material and inorganic oxide comprises a composition comprising aggregates comprising carbonaceous material and/or inorganic oxide and discrete linkers connecting the aggregates wherein the composition is porous.

In one embodiment, the composition comprises at least one organic compound attached to the surface of the monolith. “Attached” as used herein, refers to adsorbing, coating, covalently bonding, ionically bonding, or any noncovalent interaction between the at least one organic compound and the surface. The at least one organic compound can at least partially cover the surface, for example, fully covering or partially covering the surface, whether it be intermittent, discontinuous, patterned, or comprise a plurality of individual compounds dotting the surface.

In one embodiment, at least one inorganic group is attached to the surface. The at least one inorganic group can, for example, be those used as ion exchange groups. Exemplary inorganic groups include SO₃⁻ and NH₄⁺.

Exemplary inorganic oxides include ZrO₂ (zirconia), TiO₂ (titania), Al₂O₃ (alumina), and silica.

In one embodiment, the at least one organic compound is chosen from polymers, such as any of the polymers described herein. The polymer can be a thermoplastic polymeric group or a thermosetting polymeric group. The polymeric group can be a random polymer, alternating polymer, graft polymer, block polymer, star-like polymer, and/or comb-like polymer. In addition, the polymeric group can be a homopolymer, copolymer, terpolymer, and/or a polymer containing any number of different repeating units. Examples of polymeric groups include, but are not limited to, polycarbonates, polyethers, polyesters, polyacrylates, polymethacrylates, polystyrenes, polyamines, and polyolefins. Preferably, the polymeric group comprises a phenylether or bisphenyl ether and a substituted propanediyl group. For example, the polymeric group may be a polymer prepared from epoxy bisphenol-A, oligomers of epoxy bisphenol-A, or epoxy novolac. Also, the polymeric group can be attached to the pigment at multiple points along the polymer chain through proper choice of substituent groups on the repeating monomer units. The polymer can be a biopolymer, such as, but not limited to, polypeptides, and/or proteins, for example protein A, protein G, and bovine serum albumin (BSA).

The monolith surface, whether it comprise an inorganic oxide or carbonaceous material, can be coated or functionalized with other organic materials, whether monomeric, polymeric, or elastomeric. These organic materials include, but are not limited to, acrylics, alkyds, epoxies, formaldehydes, glycols, polyamides, polyesters, polyethers, polyimides, polyolefins, polyols, polysulfides, polyvinyl acetate, polyurethanes, and mixtures thereof, all of which are commercially available and are produced utilizing techniques known to those skilled in the art. The polyorganosiloxanes may include various functional groups, for example methyl, phenyl, vinyl, trifluoro, chloro and combinations thereof. Common polyorganosiloxanes include polydimethylsiloxanes, dimethylphenylmethylpolysiloxane or trifluoropropylmethylsiloxane. In addition the polyorganosiloxanes may be of a branched, cyclic, linear, or oligomeric nature and contain various functionalities including, for example: alkenyl groups; halo groups; hydroxy groups; carboxy groups; cyano groups; epoxy groups; amino groups; and combinations thereof. Examples of such resins are sold under a variety of trademarks including D.E.R.® Epoxy Resin, Drakeol® Mineral Oil, Polylite® Alkyd Resin, Epone® Epoxy Resin, and DC200® Silicone Oil.

Polymeric coatings can be applied to the monoliths to change their surface properties and hydrophobicity. Coatings, such as cross-linked polybutadiene and polyethylene imine, have been known to change the retention properties of ZrO₂ spherical particles for chromatographic applications and can be used to prepare particles for reversed phase or ion exchange chromatography. Applying these coatings to inorganic oxide membranes or monoliths can lead to materials for chromatographic and separation applications.

Organic groups can be attached to the surface of carbonaceous material membranes and/or monoliths to modify properties, such as hydrophobicity or hydrophilicity. In another example, the organic group can provide unique chromatographic selectivity to carbonaceous material membranes and/or monoliths for chromatographic separations. Exemplary organic groups include any one or a combination of, but not limited to:

a phenyl or naphthyl group having ionic or ionizable groups;

an amino acid or derivatized amino acid, cyclodextrin, immobilized protein, polypeptide, and combinations thereof;

a fluorinated group such as a C₆F₅ group, a trifluoromethyl phenyl group, a bis-trifluorophenyl group, and combinations thereof;

L-(CₙH₂ₙ₊₁)ₓ groups, wherein n is ranges from 1 to 30 and x ranges from 1 to 3;

L-((CₙH₂ₙ)SO₂CH═CH₂)ₘ, wherein n ranges from 0 to 20 and m ranges from 1 to 3;

chiral ligands;

L-C(CH₃)₃;

L-((CₙH₂ₙ)CN)ₘ wherein n ranges from 0 to 20, and m ranges from 1 to 3;

L-((CₙH₂ₙ)C(O)N(H)—CₓH₂ₓ₊₁)ₘ, wherein n ranges from 0 to 20, x ranges from 0 to 20, and m ranges from 1 to 3;

L-((CₙH₂ₙ)N(H)C(O)CₓH₂ₓ₊₁)ₘ, wherein n ranges from 0 to 20, x ranges from 0 to 20, and m ranges from 1 to 3;

L-((CₙH₂ₙ)O—C(O)—N(H)—CₓH₂ₓ₊₁), wherein n ranges from 0 to 20, and m ranges from 1 to 3;

L-((CₙH₂ₙ)C(O)N(H)—R)ₘ, wherein n ranges from 0 to 20, x ranges from 0 to 20, m ranges from 1 to 3, and R is an organic group capable of bonding to the nitrogen atom of amides;

L-((CₙH₂ₙ)N(H)C(O)—R)ₘ, wherein n ranges from 0 to 20, x ranges from 0 to 20, m ranges from 1 to 3, and R is an organic group capable of bonding to the nitrogen atom of amides;

L-((CₙH₂ₙ)O—C(O)N(H)—R)ₘ, wherein n ranges from 0 to 20, x ranges from 0 to 20, m ranges from 1 to 3, and R is an organic group capable of bonding to the nitrogen atom of amides;

optically active amino acids and derivatized optically active amino acid;

cyclodextrin attached through —Ar(CH₂)ₙ, wherein n ranges from 0 to 15.

polyethylene glycol, methoxy-terminated polyethylene glycol, resins derivatized with polyethylene glycol, and resins derivatized with methoxy-terminated polyethylene glycol;

L-(CH₂)ₘ(O(CH₂)_{y})ₙNR₂ and L-(CH₂)ₘ(O(CH₂)_{y})ₙN⁺R₃, wherein m, y, and n are independently chosen from zero and an integer; and R is chosen from hydrogen and alkyls, such as methyl and ethyl;

L-C(O)(O(CH₂)_{y})ₙNR₂ and L-C(O)(O(CH₂)_{y})ₙN⁺R₃, wherein y and n are independently chosen from zero and an integer; and R is chosen from hydrogen and alkyls, such as methyl and ethyl;

L-C(O)NH(CH₂)ₘ(O(CH₂)_{y})ₙNR₂ and L-C(O)NH(CH₂)ₘ(O(CH₂)_{y})ₙN⁺R₃, wherein m, y, and n are independently chosen from zero and an integer; and R is chosen from hydrogen and alkyls, such as methyl and ethyl;

L-(CH₂)ₘ(O(CH₂)_{y})ₙCOOH, wherein m, y, and n are independently chosen from zero and an integer; and R is chosen from hydrogen and alkyls, such as methyl and ethyl;

L-(CH₂)ₘ(O(CH₂)_{y})ₙSO₃H, wherein m, y, and n are independently chosen from zero and an integer;

L-(CH₂)ₘ(O(CH₂)_{y})ₙSO₃H, wherein m, y, and n are independently chosen from zero and an integer;

L-((CₙH₂ₙ)COOX)ₘ, wherein n ranges from 0 to 20, m ranges from 1 to 3, and X is chosen from hydrogen, cations, such as metal cations, quaternary ammonium groups, and other organic groups capable of bonding to a carboxylate;

L-((CₙH₂ₙ)OH)ₘ, wherein n ranges from 0 to 20, and m ranges from 1 to 3;

L-((CₙH₂ₙ)NR₂)ₘ, wherein n ranges from 0 to 20, m ranges from 1 to 3, and R is chosen from hydrogen and alkyls, such as methyl or ethyl;

L-((CₙH₂ₙ)NR₃X)ₘ, wherein X is an anion, and R is chosen from hydrogen and alkyls, such as methyl or ethyl;

L-((CₙH₂ₙ)CHNR₃⁺COO⁻)ₘ wherein n ranges from 0 to 20, and R is chosen from hydrogen and alkyls, such as methyl or ethyl;

groups resulting from the reaction between (a) -L-((CₙH₂ₙ)CHNR₃⁺COO⁻)ₘ wherein n ranges from 0 to 20, and R is chosen from hydrogen and alkyls, such as methyl and ethyl, and (b) compounds containing substituents chosen from amines, hydroxyls, and carboxylic acids;

L-R wherein R is an ionic or ionizable group;

L-((CₙH₂ₙ)CH═CH₂)ₘ, wherein n ranges from 0 to 20 and m ranges from 1 to 3; and

a ligand, for binding a target.

As used herein “L” is:

Ar, an aromatic group; in one embodiment, L is Ar when the surface is carbonaceous material;

chosen from siloxanes and polysiloxanes when the surface is silicon; or

chosen from any of the linkers described herein (i.e., unused linkers or unused linker sites) such as (1) electrophilic linkers; (2) nucleophilic linkers; (3) linkers that take part in cycloaddition or electrocyclic bond forming reactions; and (4) linkers that form strong associations through non-covalent interactions such as hydrogen bonding, salt bridges, and hydrophobic interactions, such as:

(1) Electrophilic linkers chosen from:

carboxylic acid and esters;

carboxylic acid halides such as those chosen from chlorides, fluorides, and acyl azides and anhydrides;

activated esters of carboxylic acids such as those chosen from pentafluorophenol, N-hydroxysuccinamide and hydroxybenzotriazole;

sulfonyl halides, sulfonyl azides and sulfonyl isocyanates;

isocyanates and isothiocyanates and blocked forms of isocyanates, such as malonate adducts;

ketones and aldehydes;

amides, hydroxymethylamides, ureas and hydroxymethylureas, melamine-formaldehyde adducts and urea-formaldehyde adducts;

imides;

imines;

linear and cyclic α,β-Unsaturated ketones, aldehydes, and nitriles, sulphones, sulfoxides, phosphonates, etc and precursors thereof as a result of β-elimination or other fragmentation reactions;

alkylating agents, such as those chosen from alkyl halides, epoxides, thioepoxides, aziridines, mono and disubstituted halo-triazines and pyrimidines, oxazolines, alkyl and cyclic sulfonates, sulfates and phosphates, etc.; and

aromatic compounds that undergo addition-elimination reactions, such as o-fluoronitrobenzene;

(2) Nucleophilic linkers chosen from:

amines, hydroxylamines, and hydrazines;

alcohols and alcoholates;

phenols and phenolates;

thiols and thiolates;

carboxylates, and salts of thioacids, xanthates and cyanurates;

amides, hydrazides, sulfonamides and acylated sulfonamides;

oximes;

carbanions and their precursors, such as those chosen from malonates, cyanoacetate and α-cyanosulphones;

imides, such as phthalimide and succinimide; and

electron rich aromatic rings;

(3) Linkers that take part in cycloaddition or electrocyclic bond forming reactions, wherein the cycloaddition reactions occur between dienes and dieneophiles. Thus, the linkers can be dienes that are either linear or cyclic. Exemplary dienes include those chosen from 1,3-butadienes, cyclopentadienes, furans, and oxazoles. Alternatively the linkers can be dienophiles chosen from exemplary dienophiles α,β-unsaturated ketones, aldehydes, nitriles, sulphones, and groups containing electron deficient double bonds such as those chosen from maleamide and esters of maleic acid. Electrocyclic reactions include the Ene reaction where a dieneophile reacts with an olefin bearing at least one allylic hydrogen (the ‘ene’). Examples of such olefinic groups include those chosen from allyl alcohols and ethers, α-olefins and allyl aromatics. Alternatively, the linker can be an olefin group that reacts with a dienophile.

(4) Linkers capable of non-covalent interactions such as those chosen from hydrogen bonding, salt bridges, and hydrophobic interactions. Examples of groups capable of forming strong hydrogen bonds include those chosen from aminotriazines, cyanurates, pyrimidines, uracils and the like. Salt bridges may form between groups of opposite charge, for example sulphonate salts and salts of amines. Examples of hydrophobic interactions include fatty acid esters or hydrophobic polymers in aqueous media.

Immobilized protein, which can be useful, for example, in the separation of racemic mixtures into their optically pure components. Cyclodextrin attached through a group —Ar(CH₂)ₙ, wherein n=0 to 15, can be useful, for example, in the separation of racemic mixtures into their optically pure components. Optically active amino acid or derivatized amino acid, can also be useful, for example, in the separation of racemic mixtures into their optically pure components.

In another embodiment, the oxide can be coated with a ligand selected to bind a desired target molecule. The ligands can include nitrogen-, sulfur-, phosphorus-, or oxygen-terminated groups and combinations thereof. Other ligands are known to those skilled in the art. More specific applications include, for example, use of the Lewis acid sites of ZrO₂ and TiO₂, which can be used to strongly adsorb a variety of chiral selectors, such as polysaccharides, or derivatized amino acids and their phosphonic acid or catechol derivatives. Coating membranes and/or monoliths with such chiral selectors can enable novel preparative separations of enantiomers. Chiral selectors can be covalently attached to carbonaceous material.

The Lewis acid sites of ZrO₂, and TiO₂ can be used to strongly adsorb chelating chemicals, such as ethylene diamine tetramethyl phosphonic acid. The coating can be used to passivate the surfaces of these materials towards non-specific adsorption of proteins. This chemistry on particles has been shown to have some advantages in monoclonal antibody purification versus protein A supports in chromatographic separations. Applying this chemistry to membranes and/or monoliths can enable novel preparative-scale protein purification technologies. Also, attaching specific affinity ligands to the surface of carbonaceous material membranes and/or monoliths can create supports with enhanced properties for the preparative purification of proteins

As a specific example, HPLC products can comprise the monoliths based on zirconia for the separation of small molecules and enantiomers. In other examples, there are commercially available membranes that use a ZrO₂/TiO₂ coating on a carbon monolith support for size exclusion. These membranes can be further coated with the organic groups described herein to enhance separation and selectivity. Organic coatings can also be applied to ZrO₂ or TiO₂-coated AlO₃—TiO₂ monolithic supports. The resulting membrane and/or monolith would be ultra stable membranes/monoliths tunable surface properties that could significantly enhance the state of the art in a variety of separations applications. Commercially available carbon monolithic membranes, for example, carbocor by Koch industries, can also be employed.

Another aspect of the invention provides a composition comprising a porous monolith comprising a material chosen from titania and zirconia and at least one organic compound at least partially coating the surface of the monolith. The at least one organic compound can be any molecule or polymer capable of attaching to a oxide surface, as described herein.

Another aspect of the invention provides a composition comprising a material, the surface of the material being bonded to at least one organic group having a formula chosen from:

L-(CH₂)ₘ(O(CH₂)_{y})ₙNR₂ and L-(CH₂)ₘ(O(CH₂)_{y})ₙN⁺R₃, wherein m, y, and n are independently chosen from zero and an integer; and R is chosen from hydrogen and alkyls, such as methyl and ethyl;

L-C(O)(O(CH₂)_{y})ₙNR₂ and L-C(O)(O(CH₂)_{y})ₙN⁺R₃, wherein y and n are independently chosen from zero and an integer; and R is chosen from hydrogen and alkyls, such as methyl and ethyl;

L-C(O)NH(CH₂)ₘ(O(CH₂)_{y})ₙNR₂ and L-C(O)NH(CH₂)ₘ(O(CH₂)_{y})ₙN⁺R₃, wherein m, y, and n are independently chosen from zero and an integer; and R is chosen from hydrogen and alkyls, such as methyl and ethyl;

L-(CH₂)ₘ(O(CH₂)_{y})ₙCOOH, wherein m, y, and n are independently chosen from zero and an integer; and R is chosen from hydrogen and alkyls, such as methyl and ethyl;

L-(CH₂)ₘ(O(CH₂)_{y})ₙSO₃H, wherein m, y, and n are independently chosen from zero and an integer; and

L-(CH₂)ₘ(O(CH₂)_{y})ₙSO₃H, wherein m, y, and n are independently chosen from zero and an integer.

Where “L” is defined as above.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

What is claimed is:

1. A composition comprising:
carbonaceous material and/or an inorganic oxide comprising aggregates comprising particles; and
discrete linkers connecting the aggregates;
wherein the composition is porous.

2. The composition according to claim 1, wherein the composition comprises a continuous network of the aggregates.

3. The composition according to claim 1, wherein at least one of the discrete linkers is adhered to at least two of the aggregates.

4. The composition according to claim 3, wherein at least one of the discrete linkers is covalently bonded to at least one of the aggregates.

5. The composition according to claim 3, wherein at least one of the discrete linkers acts as an adhesive to connect the aggregates.

6. The composition according to claim 1, wherein each aggregate has pores defined by the particle surfaces, the pores having a mean diameter ranging from 5 nm to 200 nm.

7. The composition according to claim 1, wherein the composition has pores defined by the aggregate surfaces, the pores having a mean diameter ranging from 25 nm to 10 μm.

8. The composition according to claim 7, wherein at least 50% of the pores by volume have a diameter ranging from 25 nm to 10 μm.

9. The composition according to claim 7, wherein the composition has pores defined by the aggregate surfaces, the pores having a mean diameter ranging from 25 nm to 1 μm.

10. The composition according to claim 1, wherein the composition has a void volume ranging from 45% to 95% relative to the total volume of the composition.

11. The composition according to claim 1, wherein the composition comprises flow channels.

12. The composition according to claim 11, wherein a first fraction of the flow channels has a mean diameter ranging from 5 nm to 200 nm.

13. The composition according to claim 12, wherein a second fraction of the flow channels has a mean diameter ranging from 25 nm to 10 μm.

14. The composition according to claim 13, wherein a third fraction of the flow channels has a mean diameter ranging from 500 nm to 50 μm.

15. The composition according to claim 14, wherein the third fraction of the flow channels has a mean diameter ranging from 500 nm to 20 μm.

16. The composition according to claim 14, wherein the third fraction of the flow channels has a mean diameter ranging from 1 μto 20 μm.

17. The composition according to claim 1, wherein the composition has a surface area ranging from 10 to 300 m² per mL of the composition.

18. The composition according to claim 1, wherein the particles comprise at least one substance chosen from ceramics, carbonaceous material, metals, and polymers.

19. The composition according to claim 18, wherein the particles comprise ceramics chosen from oxides, nitrides, carbides, selenides, arsenides, and borides.

20. The composition according to claim 19, wherein the particles are oxides chosen from silica, alumina, ceria, titania, zirconia, boria, chromia, aluminosilicates, tin oxide, and nickel oxide.

21. The composition according to claim 20, wherein the particles are oxides chosen from silica, alumina, ceria, titania, and zirconia.

22. The composition according to claim 18, wherein the particles comprise metals chosen from gold, silver, platinum, iron, nickel, and palladium.

23. The composition according to claim 18, wherein the particles comprise carbonaceous material chosen from carbon black, fumed carbon black, nanotubes, fullerenes, buckminsterfullerenes, vitreous carbon, and carbon allotropes.

24. The composition according to claim 18, wherein the particles are polymers having a T_{g} of at least 100° C.

25. The composition according to claim 1, wherein the discrete linkers are chosen from organic molecules, inorganic molecules, polymers, and biopolymers.

26. The composition according to claim 25, wherein the discrete linkers are organic molecules chosen from electrophiles, nucleophiles, molecules that participate in cycloaddition or electrocyclic bond forming reactions, and molecules that form non-covalent interactions.

27. The composition according to claim 25, wherein the discrete linkers are polymers chosen from polyorganosiloxanes, alkyds, epoxies, polyamides, polyesters, polyethers, polyimides, polyolefins, polyols, polysulfides, polyvinyl acetate, polyurethanes, polycarbonates, polyacrylates, polymethacrylates, polystyrenes, and polyamines.

28. The composition according to claim 25, wherein the discrete linkers are biopolymers chosen from proteins, nucleic acids, and polypeptides.

29. The composition according to claim 1, wherein the discrete linkers are cross-linkers capable of cross-linking with each other.

30. The composition according to claim 1, wherein the surface of the composition is derivatized.

31. The composition according to claim 30, wherein the linkers are derivatized.

32. The composition according to claim 30, wherein the aggregates are derivatized.

33. The composition according to claim 1, wherein at least one physical property of the linker is responsive to at least one environmental condition.

34. The composition according to claim 33, wherein the at least one physical property is chosen from pore size, binding strength, binding capability, flexibility, and linker conformation.

35. The composition according to claim 33, wherein the at least one environmental condition is chosen from pH, electric field, magnetic field, temperature, solvent, ionic strength, rheology, shear, and light.

36. A monolith, comprising the composition according to claim 1.

37. The monolith according to claim 36, wherein the monolith is a bead.

38. A membrane, comprising the composition according to claim 1.

39. The membrane according to claim 38, wherein the membrane is a film.

40. The membrane according to claim 38, wherein the linkers are chosen from organic molecules and inorganic molecules.

41. A chromatographic support, comprising the composition according to claim 1.

42. A composition comprising:
carbonaceous material and/or an inorganic oxide comprising particles having a mean diameter of at least 5 nm; and
discrete linkers connecting the particles;
wherein the composition is porous.

43. The composition according to claim 42, wherein the particles have a mean diameter of at least 10 nm.

44. A method of making a composition, comprising:
providing a carbonaceous material and/or an inorganic oxide comprising aggregates comprising particles;
combining discrete linkers with the aggregates; and
forming a continuous network comprising the aggregates.

45. The method according to claim 44, wherein the continuous network comprises the aggregates dispersed in a liquid medium.

46. The method according to claim 45, wherein the particles are lyophobic.

47. The method according to claim 46, wherein the particles are lyophilic, and the method further comprises treating the lyophilic particles to render them lyophobic.

48. The method according to claim 47, wherein the treating comprises modifying the surface of the particles.

49. The method according to claim 45, wherein the forming precedes the combining and the continuous network comprises the aggregates free of the discrete linkers.

50. The method according to claim 45, wherein the combining precedes the forming and the continuous network comprises the aggregates and the discrete linkers.

51. The method according to claim 44, wherein the combining comprises binding the discrete linkers with the aggregates.

52. The method according to claim 51, wherein the binding connects the aggregates with each other.

53. The method according to claim 51, wherein the binding comprises covalently bonding the linkers to the aggregates.

54. The method according to claim 51, wherein after the binding, the method further comprises connecting the aggregates with each other.

55. The method according to claim 54, wherein the connecting comprises cross-linking the linkers with each other.

56. The method according to claim 44, wherein the network exists in a liquid medium as a floc network.

57. The method according to claim 56, wherein the particles are present in the floc network in an amount ranging from 0.5% to 50% by volume relative to the total volume of the composition.

58. The method according to claim 57, wherein the particles are present in the floc network in an amount ranging from 5% to 50% by volume relative to the total volume of the composition.

59. The method according to claim 56, wherein the floc network comprises the aggregates free of the discrete linkers.

60. The method according to claim 56, wherein the floc network comprises the aggregates and the discrete linkers.

61. The method according to claim 60, wherein the floc network comprises the discrete linkers connecting the aggregates.

62. The method according to claim 44, wherein the continuous network is a solid comprising the aggregates connected through the discrete linkers.

63. The method according to claim 62, wherein the discrete linkers are covalently bonded to the aggregates.

64. The method according to claim 44, wherein the combining further comprises combining the discrete linkers, the aggregates, and removable substances having a dimension ranging from 500 nm to the maximum dimension of the network.

65. The method according to claim 64, wherein the removable substances are removed by a process chosen from etching, leaching, solubilizing, and burning.

66. The method according to claim 64, wherein the removable substances are chosen from silica, waxes, biodegradable substances, thermally degradable substances, photodegradable substances, and carbon.

67. The method according to claim 64, further comprising removing the removable substances from the continuous network to form voids.

68. The method according to claim 67, wherein the voids have a mean diameter ranging from 500 nm to 50 μm.

69. The method according to claim 68, wherein the voids have a mean diameter ranging from 500 nm to 20 μm.

70. The method according to claim 69, wherein the voids have a mean diameter ranging from 1 μm to 20 μm.

71. The method according to claim 44, further comprising modifying the surface of the network.

72. The method according to claim 71, wherein the surface of the network is modified by derivatizing the linkers.

73. The method according to claim 71, wherein the surface of the network is modified by derivatizing the surface of the aggregates.

74. A composition comprising:
a porous monolith comprising a material chosen from carbonaceous material and/or an inorganic oxide; and
at least one organic compound attached to the surface of the monolith.

75. The composition according to claim 74, wherein the at least one organic compound is attached to the surface by coating the surface, adsorbing to the surface, or covalently bonding to the surface.

76. The composition according to claim 74, wherein the at least one organic compound is a polymer.

77. The composition according to claim 76, wherein the polymer is chosen from polyorganosiloxanes, polycarbonates, polyethers, polyesters, polyacrylates, polymethacrylates, polystyrenes, polyamines, polyolefins, and polysaccharides.

78. The composition according to claim 74, wherein the at least one organic compound is chosen from:
phenyl and naphthyl groups having ionic or ionizable groups;
fluorinated groups;
Ar—(CₙH₂ₙ₊₁)ₓ groups, wherein Ar is an aromatic group, n is ranges from 1 to 30, and x ranges from 1 to 3;
Ar—((CₙH₂ₙ)SO₂CH═CH₂)ₘ, wherein Ar is an aromatic group, n ranges from 0 to 20 and m ranges from 1 to 3;
chiral ligands;
Ar—C(CH₃)₃, wherein Ar is an aromatic group;
Ar—((CₙH₂ₙ)CN)ₘ wherein Ar is an aromatic group, n ranges from 0 to 20, and m ranges from 1 to 3;
Ar—((CₙH₂ₙ)C(O)N(H)—CₓH₂ₓ₊₁)ₘ, wherein Ar is an aromatic group, n ranges from 0 to 20, x ranges from 0 to 20, and m ranges from 1 to 3;
Ar—((CₙH₂ₙ)N(H)C(O)CₓH₂ₓ₊₁)ₘ, wherein Ar is an aromatic group, n ranges from 0 to 20, x ranges from 0 to 20, and m ranges from 1 to 3;
Ar—((CₙH₂ₙ)O—C(O)—N(H)—CₓH₂ₓ₊₁), wherein Ar is an aromatic group, n ranges from 0 to 20, and m ranges from 1 to 3;
Ar—((CₙH₂ₙ)C(O)N(H)—R)ₘ, wherein Ar is an aromatic group, n ranges from 0 to 20, x ranges from 0 to 20, m ranges from 1 to 3, and R is an organic group;
Ar—((CₙH₂ₙ)N(H)C(O)—R)ₘ, wherein Ar is an aromatic group, n ranges from 0 to 20, x ranges from 0 to 20, m ranges from 1 to 3, and R is an organic group;
Ar—((CₙH₂ₙ)O—C(O)N(H)—R)ₘ, wherein Ar is an aromatic group, n ranges from 0 to 20, x ranges from 0 to 20, m ranges from 1 to 3, and R is an organic group;
optically active amino acids and derivatized optically active amino acid; and
cyclodextrin attached through —Ar(CH₂)ₙ, wherein Ar is an aromatic group and n ranges from 0 to 15.

79. The composition according to claim 74, wherein the at least one organic compound is chosen from amino acids, derivatized amino acids, cyclodextrin, proteins, and polypeptides.

80. The composition according to claim 74, wherein the at least one organic compound is chosen from polyethylene glycol, methoxy-terminated polyethylene glycol, resins derivatized with polyethylene glycol, and resins derivatized with methoxy-terminated polyethylene glycol.

81. The composition according to claim 74, wherein the at least one organic compound is a group having a formula chosen from —Ar—(CH₂)ₘ(O(CH₂)_{y})ₙNR₂ and Ar—(CH₂)ₘ(O(CH₂)_{y})ₙN⁺R₃, wherein Ar is an aromatic group; m, y, and n are independently chosen from zero and an integer; and R is chosen from hydrogen and alkyls.

82. The composition according to claim 74, wherein the at least one organic compound is a group having a formula chosen from —Ar—C(O)(O(CH₂)_{y})ₙNR₂ and Ar—C(O)(O(CH₂)_{y})ₙN⁺R₃, wherein Ar is an aromatic group; y and n are independently chosen from zero and an integer; and R is chosen from hydrogen and alkyls.

83. The composition according to claim 74, wherein the at least one organic compound is a group having a formula chosen from —Ar—C(O)NH(CH₂)ₘ(O(CH₂)_{y})ₙNR₂ and Ar—C(O)NH(CH₂)ₘ(O(CH₂)_{y})ₙN⁺R₃, wherein Ar is an aromatic group; m, y, and n are independently chosen from zero and an integer; and R is chosen from hydrogen and alkyls.

84. The composition according to claim 74, wherein the at least one organic compound has a formula —Ar—(CH₂)ₘ(O(CH₂)_{y})ₙCOOH, wherein Ar is an aromatic group; m, y, and n are independently chosen from zero and an integer; and R is chosen from hydrogen and alkyls.

85. The composition according to claim 74, wherein the at least one organic compound has a formula —Ar—(CH₂)ₘ(O(CH₂)_{y})ₙSO₃H, wherein Ar is an aromatic group, and m, y, and n are independently chosen from zero and an integer.

86. The composition according to claim 74, wherein the at least one organic compound has a formula —Ar—(CH₂)ₘ(O(CH₂)_{y})ₙSO₃H, wherein Ar is an aromatic group, and m, y, and n are independently chosen from zero and an integer.

87. The composition according to claim 74, wherein the at least one organic compound has a formula —Ar—((CₙH₂ₙ)COOX)ₘ, wherein Ar is an aromatic group, n ranges from 0 to 20, m ranges from 1 to 3, and X is chosen from hydrogen, cations, and organic groups.

88. The composition according to claim 74, wherein the at least one organic compound has a formula —Ar—((CₙH₂ₙ)OH)ₘ, wherein Ar is an aromatic group, n ranges from 0 to 20, and m ranges from 1 to 3.

89. The composition according to claim 74, wherein the at least one organic compound has a formula —Ar—((CₙH₂ₙ)NR₂)ₘ, wherein Ar is an aromatic group, n ranges from 0 to 20, m ranges from 1 to 3, and R is chosen from hydrogen and alkyls.

90. The composition according to claim 74, wherein the at least one organic compound has a formula —Ar—((CₙH₂ₙ)NR₃X)ₘ, wherein X is an anion, Ar is an aromatic group, and R is chosen from hydrogen and alkyls.

91. The composition according to claim 74, wherein the at least one organic compound has a formula —Ar—((CₙH₂ₙ)CHNR₃⁺COO⁻)ₘ wherein Ar is an aromatic group, n ranges from 0 to 20, and R is chosen from hydrogen and alkyls.

92. The composition according to claim 74, wherein the at least one organic compound is chosen from groups resulting from the reaction between (a) —Ar—((CₙH₂ₙ)CHNR₃⁺COO⁻)ₘ wherein Ar is an aromatic group, n ranges from 0 to 20, and R is chosen from hydrogen and alkyls, and (b) compounds containing substituents chosen from amines, hydroxyls, and carboxylic acids,

93. The composition according to claim 74, wherein the at least one organic compound has a formula —Ar—((CₙH₂ₙ)CH═CH₂)ₘ, wherein Ar is an aromatic group, n ranges from 0 to 20 and m ranges from 1 to 3.

94. The composition according to claim 74, wherein the at least one organic compound is a ligand, for binding a target.

95. A chromatography column comprising the composition according to claim 74.

96. A membrane comprising the composition according to claim 74.

97. The membrane according to claim 96, wherein the membrane is a film.

98. A composition comprising a material, the surface of the material being bonded to an organic group having a formula chosen from:
—Ar—(CH₂)ₘ(O(CH₂)_{y})ₙNR₂ and Ar—(CH₂)ₘ(O(CH₂)_{y})ₙN⁺R₃, wherein Ar is an aromatic group; m, y, and n are independently chosen from zero and an integer; and R is chosen from hydrogen and alkyls;
—Ar—C(O)(O(CH₂)_{y})ₙNR₂ and Ar—C(O)(O(CH₂)_{y})ₙN⁺R₃, wherein Ar is an aromatic group; y and n are independently chosen from zero and an integer; and R is chosen from hydrogen and alkyls;
—Ar—C(O)NH(CH₂)ₘ(O(CH₂)_{y})ₙNR₂ and Ar—C(O)NH (CH₂)ₘ(O(CH₂)_{y})ₙN⁺R₃, wherein Ar is an aromatic group; m, y, and n are independently chosen from zero and an integer; and R is chosen from hydrogen and alkyls;
—Ar—(CH₂)ₘ(O(CH₂)_{y})ₙCOOH, wherein Ar is an aromatic group; m, y, and n are independently chosen from zero and an integer; and R is chosen from hydrogen and alkyls;
—Ar—(CH₂)ₘ(O(CH₂)_{y})ₙSO₃H, wherein Ar is an aromatic group, and m, y, and n are independently chosen from zero and an integer; and
—Ar—(CH₂)ₘ(O(CH₂)_{y})ₙSO₃H, wherein Ar is an aromatic group, and m, y, and n are independently chosen from zero and an integer.

99. The composition according to claim 98, wherein the surface comprises carbonaceous material.
